(19) United States
(12) Patent Application Publication
(10) Pub. No.: US 2026/0188921 A1
(43) Pub. Date: Jul. 2, 2026

(54) TERMINAL BLOCK

(71) Applicant: Yazaki Corporation, Tokyo (JP)

(72) Inventor: Wataru HASEGAWA, Shizuoka (JP)

(73) Assignee: Yazaki Corporation, Tokyo (JP)

(21) Appl. No.: 19/422,736

(22) Filed: Dec. 17, 2025

(30) Foreign Application Priority Data
Dec. 26, 2024 (JP) 2024-230086

(51) Int. Cl. H01R 9/24

(52) U.S. Cl. CPC H01R 9/24

(57) ABSTRACT

A terminal block includes a housing that holds a plurality of terminals, a holder press-fitted into and assembled to the housing, and a nut held by the holder and screwed with a bolt, the bolt passing through a corresponding one of the terminals and being attached, the holder includes a press-fitting portion that is press-fitted into the housing, and the press-fitting portion includes a rib protruding from an outer surface and is press-fitted by bringing the rib into contact with the housing.

### CROSS-REFERENCE TO RELATED APPLICATION(S)

The present application claims priority to and incorporates by reference the entire contents of Japanese Patent Application No. 2024-230086 filed in Japan on December 26, 2024.

### BACKGROUND OF THE INVENTION

### 1. Field of the Invention

The present invention relates to a terminal block.

### 2. Description of the Related Art

In the related art, as a terminal block, for example, as described in Japanese Patent Application Laid-open No. 2024-79560, a terminal block including a housing for holding a terminal, a packing disposed so as to cover a periphery of the terminal, and a holder for holding the packing is known.

Such a terminal block has room for improvement in that a structure in which the holder is more firmly joined to the housing may become complicated. For example, in the above-described terminal block, the holder is press-fitted into the housing via the packing, but it may be required to more firmly join the holder to the housing. In this case, it is conceivable to engage the holder with the housing by providing a lance shape in the holder, but there is a possibility that the joining structure becomes complicated.

### SUMMARY OF THE INVENTION

Therefore, an object of the present invention is to provide a terminal block in which a holder can be appropriately joined to a housing with a simple structure.

A terminal block according to one aspect of the present invention includes a housing that holds a plurality of terminals; a holder press-fitted into and assembled to the housing; and a nut held by the holder and screwed with a bolt, the bolt passing through a corresponding one of the terminals and being attached, wherein the holder includes a press-fitting portion that is press-fitted into the housing, and the press-fitting portion includes a rib protruding from an outer surface and is press-fitted by bringing the rib into contact with the housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to a first embodiment;

FIG. 2 is an exploded perspective view of the terminal block according to the first embodiment;

FIG. 3 is a perspective view of a holder of the terminal block according to the first embodiment;

FIG. 4 is a sectional view of the terminal block taken along line IV-IV in FIG. 1;

FIG. 5 is an exploded perspective view of a terminal block according to a second embodiment;

FIG. 6 is a side view of the terminal block according to the second embodiment;

FIG. 7 is a front view of the terminal block according to the second embodiment;

FIG. 8 is a perspective view of a nut holder of the terminal block according to the second embodiment; and

FIG. 9 is an explanatory view of a clearance between the nut holder and a nut in the terminal block according to the second embodiment.

### DETAILED DESCRIPTION OF THE PREFERRED EMBODIMENTS

Hereinafter, embodiments according to the present invention will be described in detail with reference to the drawings. The present invention is not limited by the embodiments. In addition, components in the following embodiments include those that can be easily replaced by those skilled in the art or those that are substantially the same.

### Embodiments

The present embodiment relates to a terminal block. In the following description, among a first direction, a second direction, and a third direction intersecting with each other, the first direction is referred to as a "connection direction X", the second direction is referred to as a "width direction Y", and the third direction is referred to as a "height direction Z". Here, the connection direction X, the width direction Y, and the height direction Z are orthogonal to each other. The term "orthogonal" as used herein includes substantially orthogonal. The connection direction X corresponds to a connection direction between the terminal block and a connection target and a connection direction of a terminal. In addition, respective directions used in the following description represent directions in a state where respective portions are assembled to each other unless otherwise specified.

A terminal block 1 according to a first embodiment will be described.

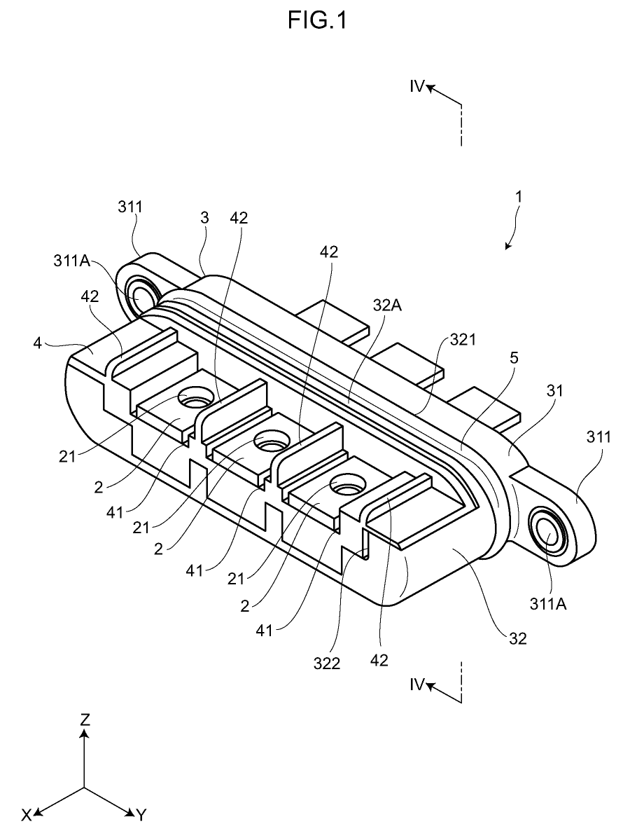

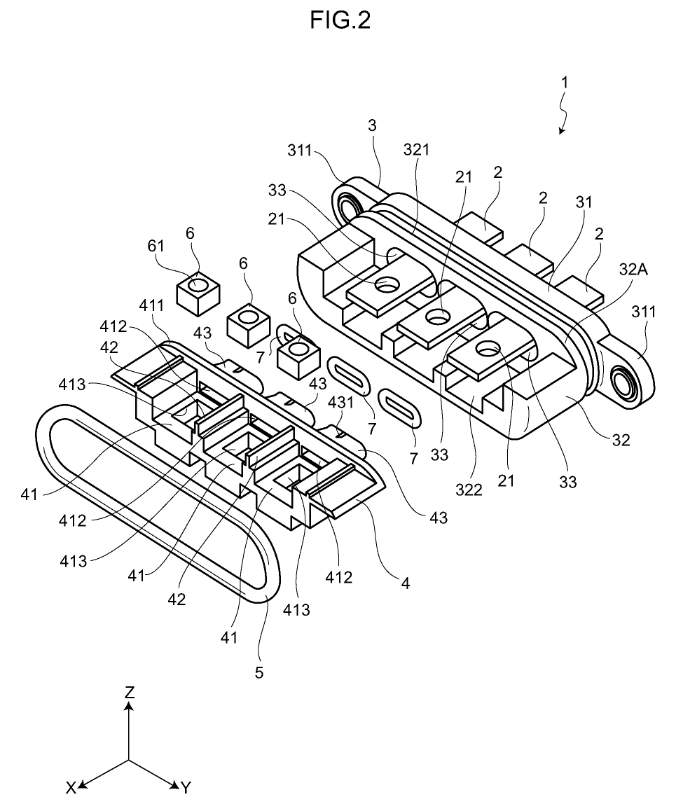

As illustrated in FIGS. 1 and 2, the terminal block 1 according to the first embodiment is a component that holds terminals 2 and is attached to an attachment object (not illustrated), for example, and is used by being mounted on a vehicle. The terminal block 1 includes the terminals 2, a housing 3, a holder 4, and nuts 6. Each terminal 2 is a terminal fitting for electrical connection, and is formed by, for example, forming a conductive metal in a plate shape. A plurality of the terminals 2 is provided and arranged in the width direction Y intersecting with the connection direction X. The terminals 2 extend in the connection direction X and are disposed in a direction intersecting with the height direction Z. For example, three terminals 2 are provided, but the number of the terminals 2 installed is not limited thereto. A through hole 21 is formed at one end of each terminal 2 in the connection direction X. Each through hole 21 is a hole through which a fastening member is inserted so as to fix a corresponding one of the terminals 2 to the holder 4. Each terminal 2 is formed so as to extend linearly, but for example, may be bent from the connection direction X to the height direction Z, or may be bent back from the height direction Z to the connection direction X to be formed in a crank shape.

The housing 3 is a component that holds the terminals 2 and is attached to the attachment object, and is made of an insulating material such as resin. The housing 3 includes a main body 31 and a terminal support 32. The main body 31 is formed in a plate shape or a block shape, and is provided in a direction intersecting with the connection direction X. The main body 31 is formed to be longer in the width direction Y than in the height direction Z, and holds the plurality of terminals 2 arranged in the width direction Y so as to allow the plurality of terminals 2 to pass therethrough in the connection direction X. The main body 31 includes flanges 311. Each flange 311 is a portion for fixing the housing 3 to the attachment object, and is provided at each end of the main body 31 in the width direction Y. Fixing holes 311A passing through the flanges 311 in the connection direction X are formed in the flanges 311.

The terminal support 32 is a portion that supports or fixes the terminals 2, and supports or fixes the terminals 2 via, for example, the holder 4. The terminal support 32 is provided continuously with the main body 31 and extends from the main body 31 in the connection direction X. The terminal support 32 is formed integrally with the main body 31, for example, and has an elliptical or oval cross-sectional shape in a direction intersecting with the connection direction X. The terminal support 32 is formed longer in the width direction Y than in the height direction Z, for example, similarly to the main body 31.

The terminal support 32 forms a holding groove 321 and an assembly portion 322. The holding groove 321 is a groove for holding a packing 5, and is formed as an annular groove along an outer periphery of the terminal support 32. The holding groove 321 is formed further on a base end side of the terminal support 32 than is the assembly portion 322. An outer peripheral surface 32A of the terminal support 32 is a water stop surface. The holding groove 321 is formed to have a size and a depth such that the packing 5 protrudes from the outer peripheral surface 32A in a state where the packing 5 is accommodated. As a result, the packing 5 appropriately stops water between the housing 3 and the attachment object. The assembly portion 322 is a recessed portion for assembling the holder 4, and is formed by recessing a leading end side of the terminal support 32 from the holding groove 321 along an outer shape of the holder 4. The plurality of terminals 2 passing through the main body 31 protrudes in the assembly portion 322. For example, the assembly portion 322 is formed by recessing a half or more of the terminal support 32.

The holder 4 is a member that is assembled to the terminal support 32 and supports ends of the terminals 2. The holder 4 is made of an insulating material such as resin. The holder 4 is assembled to the leading end side of the terminal support 32 from the assembling position of the packing 5. That is, the holder 4 is assembled to the assembly portion 322 of the terminal support 32. As described above, since the assembly portion 322 is formed further on the leading end side of the terminal support 32 than is the holding groove 321 that accommodates the packing 5, the holder 4 assembled to the assembly portion 322 is installed further on the leading end side than is the packing 5.

The holder 4 forms arrangement spaces 41 each of which allows a corresponding one of the plurality of terminals 2 to be disposed therein, and supports the ends of the plurality of terminals 2. The arrangement spaces 41 are spaces for disposing the terminals 2 extending through the main body 31, and are formed by being partitioned for the terminals 2 in the holder 4. The main body 31 side of the arrangement spaces 41 in the connection direction X is partitioned by a side wall 411. Insertion holes 412 are formed in the side wall 411. The insertion holes 412 are holes through which the terminals 2 are inserted. The terminals 2 extending from the main body 31 enter the arrangement spaces 41 through the insertion holes 412.

The adjacent arrangement spaces 41 are partitioned by partitions 42. Each partition 42 is a plate-like portion extending in the connection direction X and raised in the height direction Z, and is provided between the arrangement spaces 41. The partitions 42 partition the arrangement spaces 41 of the terminals 2 to improve the insulation of the terminals 2. The partitions 42 are formed by being raised from an installation position side of the terminals 2 to the water stop surface side of the terminal support 32. In addition, the partitions 42 are provided not only between the arrangement spaces 41 but also outside the arrangement spaces 41 formed at end positions in the width direction Y. By providing the partitions 42 in this manner, the assemblability of the packing 5 can be further improved.

As illustrated in FIG. 2, accommodating portions 413 are formed in the arrangement spaces 41 of the holder 4. The accommodating portions 413 are spaces for accommodating the nuts 6, and are formed by recessing floor portions of the arrangement spaces 41. Each nut 6 has a threaded hole 61 having a thread on an inner peripheral surface. Each accommodating portion 413 is formed at a position where the through hole 21 of a corresponding one of the terminals 2 is located in the connection direction X and the width direction Y. The accommodating portion 413 is formed in a shape corresponding to an outer shape of the nut 6, and is formed in, for example, a rectangular cross section. The outer shape of the nut 6 and the shape of the accommodating portion 413 are not limited to the rectangular cross section. In a state where the nut 6 is accommodated in the accommodating portion 413, a bolt (not illustrated) is inserted into the through hole 21 of the terminal 2 and screwed into the nut 6, whereby the terminal 2 is fastened and fixed to the holder 4 by fastening of the bolt and the nut 6.

The accommodating portion 413 has a clearance between the accommodating portion 413 and the nut 6. The clearance is a gap between the accommodating portion 413 and the nut 6, and is formed to have a size that allows movement of the nut 6 so as to enable screwing of the bolt into the nut 6. That is, since the nut 6 is accommodated in the accommodating portion 413 of the holder 4 with a clearance, the nut 6 can move in the accommodating portion 413. Therefore, when the bolt is inserted into the through hole 21 of the terminal 2, the terminal 2 can be fastened by screwing the bolt into the nut 6 without performing position management of the nut 6.

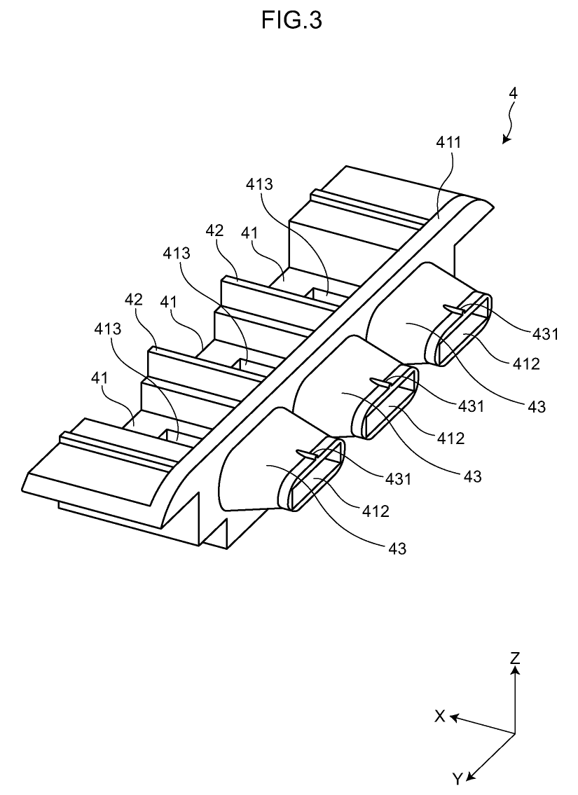

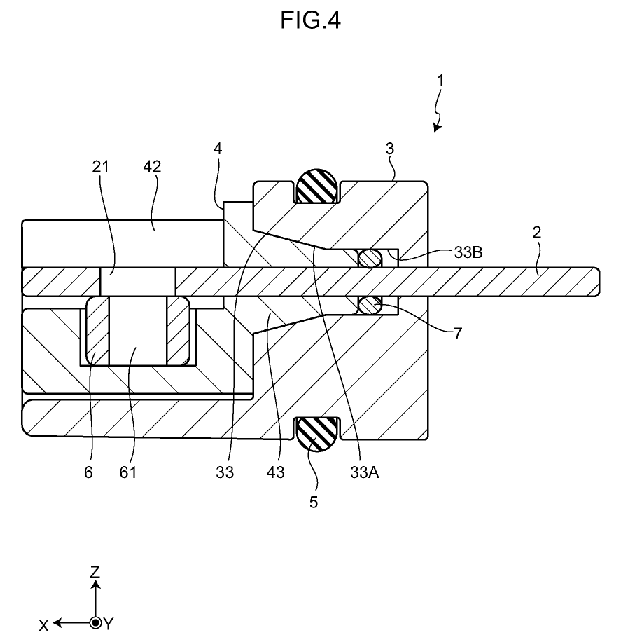

As illustrated in FIGS. 3 and 4, the holder 4 includes press-fitting portions 43 that are press-fitted into the housing 3. Each press-fitting portion 43 is, for example, a portion protruding from the side wall 411 in the connection direction X, and is formed in a tapered shape toward a protruding leading end. The insertion holes 412 are formed in the press-fitting portions 43 in the connection direction X. That is, the press-fitting portions 43 are provided so as to cover peripheries of the terminals 2 inserted into the insertion holes 412. The press-fitting portions 43 are inserted and press-fitted into joint holes 33 of the housing 3. Each joint hole 33 is formed according to the shape of the press-fitting portions 43, and is provided so as to be narrower toward the back. For example, the joint hole 33 has a tapered portion 33A that is tapered and a straight portion 33B whose hole diameter is constant from the tapered portion 33A, and passes through the housing 3. The straight portion 33B functions as an accommodating space for accommodating a water stop member 7.

Each press-fitting portion 43 has a rib 431 protruding from an outer peripheral surface. The rib 431 is provided, for example, on a leading end side of the press-fitting portion 43 and is formed to be long in the connection direction X. The rib 431 functions as a crush rib. That is, when the press-fitting portion 43 is press-fitted into a corresponding one of the joint holes 33, the rib 431 abuts on the inner surface of the joint hole 33 and is crushed, fills a gap between the press-fitting portion 43 and the joint hole 33, and brings the press-fitting portion 43 and the joint hole 33 into close contact with each other. As a result, the rib 431 prevents the press-fitting portion 43 from coming off from the joint hole 33, and the holder 4 can be appropriately joined to the housing 3 with a simple structure.

The water stop members 7 are each assembled to a corresponding one of the terminals 2. The water stop member 7 is disposed so as to cover a periphery of the terminal 2 and is attached to the housing 3. That is, the water stop member 7 is a member that stops water between the terminal 2 and the housing 3, has an annular shape, and is formed of an elastic member. The water stop members 7 are attached to the peripheries of the terminals 2 on the leading end side of the press-fitting portions 43, and are inserted into the joint holes 33 together with the press-fitting portions 43 of the holder 4. In this case, the holder 4 functions as a front holder that holds the water stop members 7.

The packing 5 is a member for stopping water between the housing 3 and the attachment object, and is assembled to the holding groove 321 of the housing 3. The packing 5 is an annular water stop member, and is formed of, for example, an elastic member. For example, the packing 5 is assembled so as to surround the terminal support 32 from a leading end side of the terminal support 32 to which the holder 4 is assembled.

Next, assembling of the terminal block 1 according to the present embodiment will be described.

The terminal block 1 is assembled by, for example, sequentially assembling the terminals 2, the holder 4, and the packing 5 to the housing 3.

As illustrated in FIG. 2, first, the terminals 2 are assembled to the housing 3. The terminals 2 are assembled to the housing 3 so as to pass through the main body 31. At this time, the terminals 2 are assembled such that the ends at which the through holes 21 are formed are located on the terminal support 32 side.

Then, the holder 4 is assembled to the housing 3. First, the water stop members 7 are each attached to a corresponding one of the terminals 2. That is, each water stop member 7 is attached to a corresponding one of the terminals 2 so as to cover the outer periphery of the terminal 2. Then, the nuts 6 are each accommodated in a corresponding one of the accommodating portions 413 of the holder 4, and the holder 4 is assembled to the assembly portion 322 of the terminal support 32 in a state where the nuts 6 are accommodated. Specifically, the terminals 2 extending from the main body 31 are inserted into the insertion holes 412, and the press-fitting portions 43 are inserted into the joint holes 33. The water stop members 7 are pressed against leading ends of the press-fitting portions 43 and slide toward the back of the joint holes 33. The press-fitting portions 43 are tightly fitted to and press-fitted into the joint holes 33.

As a result, as illustrated in FIG. 4, the rib 431 abuts on the inner surface of a corresponding one of the joint holes 33 and is crushed so as to fill the gap between the joint hole 33 and a corresponding one of the press-fitting portions 43. Therefore, the press-fitting portion 43 and the joint hole 33 are in close contact with each other and are firmly joined. That is, the ribs 431 prevent the press-fitting portions 43 from coming off from the joint holes 33, and the holder 4 can be appropriately joined to the housing 3 with a simple structure. In addition, since the press-fitting portions 43 of the holder 4 are press-fitted into the joint holes 33 so as not to come off, the water stop members 7 can be reliably held, and the water stop of the terminals 2 and the housing 3 can be secured.

Then, bolts are inserted into the through holes 21 of the terminals 2 and screwed into the threaded holes 61 of the nuts 6, and the terminals 2 are fixed to the holder 4 and the housing 3. At this time, since the nuts 6 are movably accommodated in the accommodating portions 413 with a clearance, when the bolts are inserted into the through holes 21, the bolts can be screwed into the nuts 6. In other words, the bolts can be screwed into the nuts 6 without accurately managing the positions of the nuts 6.

Then, the packing 5 is assembled to the housing 3. For example, the packing 5 is enlarged in diameter so as to surround the holder 4 and the terminal support 32, and is assembled to the holding groove 321. When the packing 5 is assembled to the housing 3, the assembly of the terminal block 1 is completed. The packing 5 may be assembled before the terminals 2 and the holder 4 are assembled to the housing 3.

As described above, in the terminal block 1 according to the present embodiment, the press-fitting portions 43 can be accurately joined to the housing 3 by forming the ribs 431 in the press-fitting portions 43 of the holder 4. Therefore, the terminal block 1 according to the present embodiment can appropriately join the holder 4 to the housing 3 with a simple structure.

In addition, in the terminal block 1 according to the present embodiment, since the holder 4 can be joined to the housing 3 by the ribs 431 of the press-fitting portions 43, it is possible to omit provision of a lock mechanism such as a lance shape. Therefore, the terminal block 1 according to the present embodiment can suppress a decrease in yield due to breakage of a lance shape or the like, and can enhance manufacturing efficiency. In addition, the terminal block 1 according to the present embodiment can be reduced in size and weight.

In addition, in the terminal block 1 according to the present embodiment, the nuts 6 are accommodated in the accommodating portions 413 of the holder 4 with a clearance, whereby the terminals 2 can be fastened by screwing the bolts into the nuts 6 without performing position management of the nuts 6. Therefore, the terminal block 1 according to the present embodiment can be manufactured with increased manufacturing efficiency.

In addition, the terminal block 1 according to the present embodiment includes the water stop members 7 disposed so as to cover the peripheries of the terminals 2 and assembled to the housing 3, and the holder 4 holds the water stop members 7. In the terminal block 1 according to the present embodiment, since the holder 4 is appropriately joined to the housing 3, the water stop members 7 can be reliably held with respect to the holder 4, and the water stop between the terminals 2 and the housing 3 can be secured.

Next, a terminal block 1A according to a second embodiment will be described.

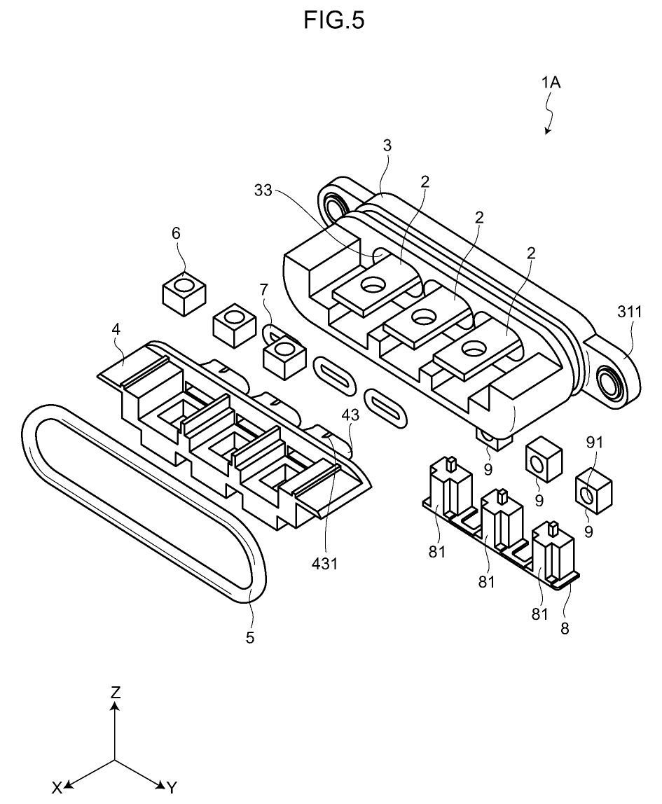

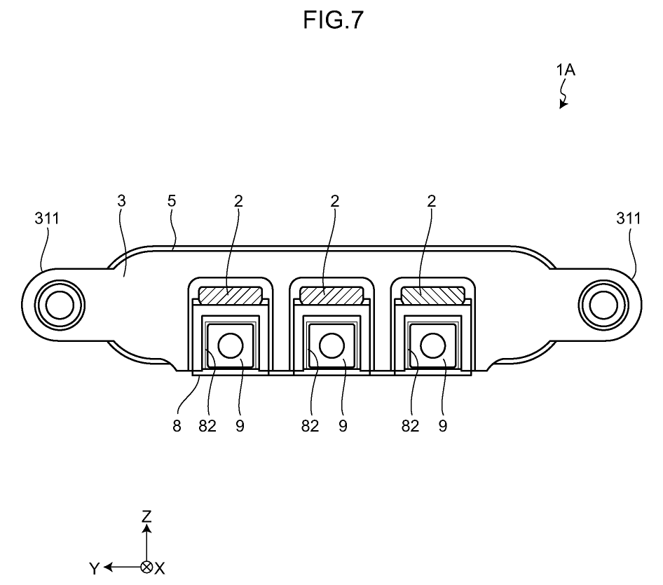

As illustrated in FIGS. 5 to 7, the terminal block 1A according to the second embodiment is configured substantially similarly to the terminal block 1 according to the first embodiment, and is different from the terminal block 1 according to the first embodiment in that a bent portion 22 is provided at one end of each terminal 2, and the bent portion 22 is fastened to the housing 3.

In the terminal block 1A, the terminal 2 has the bent portion 22 in a portion that passes through the main body 31 of the housing 3 and protrudes from the main body 31 to a side opposite to the terminal support 32. That is, the terminal 2 has the bent portion 22 in a portion that passes through the main body 31 of the housing 3 and extends from the main body 31 to a side opposite to the holder 4. The bent portion 22 is a portion bent and extending in the height direction Z from the connection direction X. The bent portion 22 is formed with a passing-through portion (not illustrated) through which a bolt member passes. The housing 3 has, for example, a protrusion 34 that protrudes from the main body 31 in the connection direction X. A nut holder 8 is disposed on the protrusion 34.

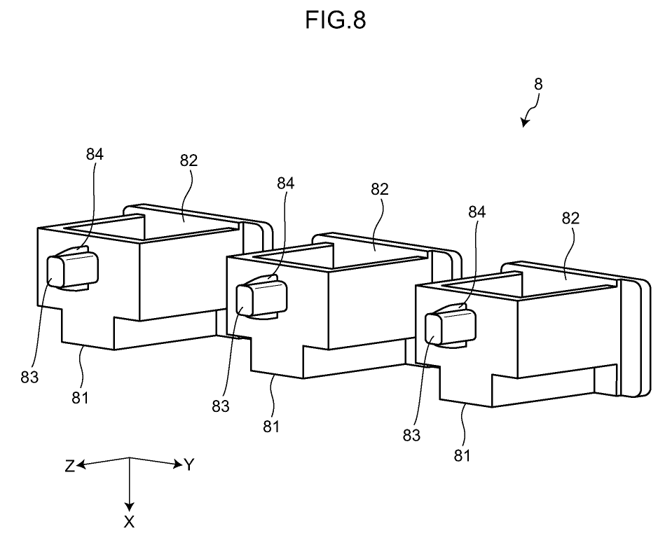

As illustrated in FIG. 8, the nut holder 8 is a component in which a plurality of nut holding portions 81 is integrally connected, and includes, for example, three nut holding portions 81. The nut holding portions 81 are arranged side by side in the width direction Y in the nut holder 8. The nut holding portions 81 are portions that accommodate and hold nut members 9. Each nut member 9 has a threaded hole 91 having a thread on an inner peripheral surface. Recessed portions 82 are formed in the nut holding portions 81. Each recessed portion 82 is a space portion for accommodating a corresponding one of the nut members 9, and is formed by recessing a corresponding one of the nut holding portions 81. The nut holding portion 81 is disposed such that an opening portion of the recessed portion 82 faces the bent portion 22 of the terminal 2.

The recessed portion 82 is formed in a shape corresponding to an outer shape of the nut member 9, and is formed in, for example, a rectangular cross section. The outer shape of the nut member 9 and the shape of the recessed portion 82 are not limited to the rectangular cross section. In a state where the nut members 9 are accommodated in the recessed portions 82, bolt members are inserted through the passing-through portions of the terminals 2 and screwed into the nut members 9, whereby the terminals 2 are fastened by fastening the bolt members and the nut members 9 and attached to the housing 3.

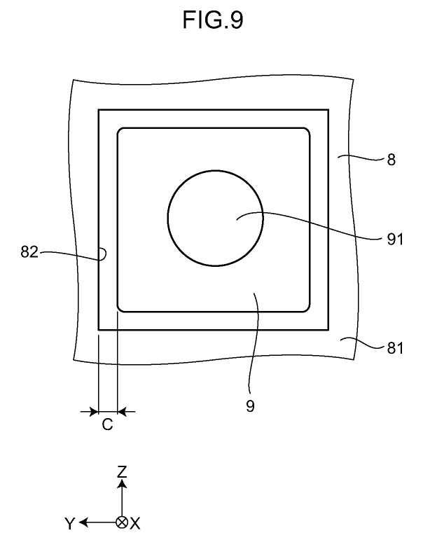

As illustrated in FIG. 9, the recessed portion 82 has a clearance C between the recessed portion 82 and the nut member 9. The clearance C is a gap between the recessed portion 82 and the nut member 9, and is formed to have a size that allows movement of the nut member 9 so as to enable screwing of the bolt member into the nut member 9. That is, since the nut member 9 is accommodated in the recessed portion 82 of the nut holder 8 with the clearance C, the nut member 9 can move in the recessed portion 82. Therefore, when the bolt member is inserted into the bent portion 22 of the terminal 2, the terminal 2 can be fastened by screwing the bolt member into the nut member 9 without performing position management of the nut member 9.

In FIG. 8, each nut holding portion 81 is provided with a projection 83. The projection 83 is a portion protruding from an outer surface of the nut holding portion 81. A rib portion 84 is formed on a side surface of the projection 83. The rib portion 84 is a crushing rib, and is used for supporting or temporarily supporting the nut holder 8 and the nut holding portion 81.

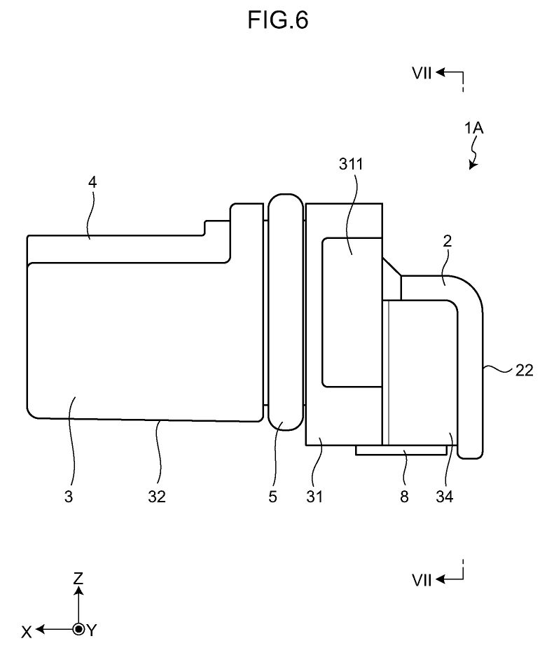

For example, in FIG. 6, when the nut holder 8 is inserted into and attached to the protrusion 34 of the housing 3 from below, the projection 83 is inserted into a hole formed in the housing 3 and the rib portion 84 is crushed, whereby the nut holding portion 81 can be joined to the housing 3.

As described above, the terminal block 1A according to the present embodiment can obtain the same operation and effect as those of the terminal block 1 according to the first embodiment described above, and further, since the nut members 9 are accommodated in the recessed portions 82 of the nut holder 8 with a clearance, the terminals 2 can be fastened by screwing the bolt members into the nut members 9 without performing position management of the nut members 9. Therefore, the terminal block 1 according to the present embodiment can be manufactured with increased manufacturing efficiency.

The terminal block according to the present invention is not limited to the above-described embodiments, and various modifications can be made within the scope described in the claims. The terminal blocks 1 and 1A according to the embodiments may be configured by appropriately combining the components of the above-described embodiments and modifications.

According to a terminal block of the present embodiment, a holder can be appropriately joined to a housing with a simple structure.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that holds a plurality of terminals;
a holder press-fitted into and assembled to the housing; and
a nut held by the holder and screwed with a bolt, the bolt passing through a corresponding one of the terminals and being attached, wherein
the holder includes a press-fitting portion that is press-fitted into the housing, and
the press-fitting portion includes a rib protruding from an outer surface and is press-fitted by bringing the rib into contact with the housing.

2. The terminal block according to claim 1, wherein
the holder forms an accommodating portion that accommodates the nut,
the accommodating portion is formed as a recess capable of accommodating the nut and has a clearance between the accommodating portion and the nut, and
the clearance is formed to have a size that allows movement of the nut to enable screwing of the bolt into the nut.

3. The terminal block according to claim 1, further comprising:
a water stop member disposed to cover a periphery of the terminal and attached to the housing, wherein
the holder functions as a front holder that holds the water stop member.

4. The terminal block according to claim 2, further comprising:
a water stop member disposed to cover a periphery of the terminal and attached to the housing, wherein
the holder functions as a front holder that holds the water stop member.

5. The terminal block according to claim 1, further comprising:
a nut member held by the housing and screwed with a bolt member, the bolt member passing through a bent portion of the terminal and being attached, wherein
the bent portion is formed by bending the terminal protruding from the housing,
the housing forms a recessed portion that accommodates the nut member,
the recessed portion is formed as a recess capable of accommodating the nut member and has a clearance between the recessed portion and the nut member, and
the clearance is formed to have a size that allows movement of the nut member to enable screwing of the bolt member into the nut member.

6. The terminal block according to claim 2, further comprising:
a nut member held by the housing and screwed with a bolt member, the bolt member passing through a bent portion of the terminal and being attached, wherein
the bent portion is formed by bending the terminal protruding from the housing,
the housing forms a recessed portion that accommodates the nut member,
the recessed portion is formed as a recess capable of accommodating the nut member and has a clearance between the recessed portion and the nut member, and
the clearance is formed to have a size that allows movement of the nut member to enable screwing of the bolt member into the nut member.
